(19) United States
(12) Patent Application Publication
(10) Pub. No.: US 2021/0332641 A1
(43) Pub. Date: Oct. 28, 2021

(54) Window Screen Systems

(71) Applicant: Unseen Screen LLC, Chicago, IL (US)

(72) Inventor: Chris LaPlaca, Chicago, IL (US)

(73) Assignee: Unseen Screen LLC

(21) Appl. No.: 16/855,349

(22) Filed: Apr. 22, 2020

(51) Int. Cl. E06B 9/52

(52) U.S. Cl. CPC E06B 9/521; E06B 2009/528; E06B 2009/527

(57) ABSTRACT

The present disclosure is directed to a window screen system for use with casement, hopper, awning, utility window designs to prevent dirt, debris, and insects from entering into the interior of the unit. The system can include an installment configured to be installed on existing window frames to provide screen protection only when the window is open and a screen is needed. As such, a user can have a clear view out of the glass window without the unsightliness, distortion, or solar blockage that a traditional “always visible” screen causes.

### BACKGROUND OF THE INVENTION

The present invention relates to a window screen apparatus. More specifically, the present invention relates to an apparatus that can be used to place a screen on casement windows and the like.

Many condominiums, apartments, and standalone homes feature windows that cannot accommodate a traditional window screen. One common example is that of casement windows, which push or pull inwards or outwards to open (and move the opposite direction to close). This inward and outward movement prevents the use of traditional full window screens that run parallel to windows; commonly seen with sash windows that feature an alternative push up/pull down movement.

While both methods of window opening have their advantages, a drawback of casement windows and other windows, which cannot accommodate a traditional screen, is the inability to stop bugs and other pests from entering a dwelling while the window is open. Particularly with respect to high rise buildings with awning type windows, the windows do not have space inside the frame to allow for a screen.

In the United States, the entrance of such pests into the home is presently an annoyance that has the potential to become a serious public health concern with the proliferation of diseases transmitted by such pests. Additionally, globally, mosquito transmitted diseases are the number one cause of death in many countries.

Accordingly, there is a need for a window screen apparatus that can be used with casement windows and the like.

### BRIEF SUMMARY OF THE INVENTION

To meet the needs described above the present disclosure is directed to a window screen system for use with windows to prevent dirt, debris, and insects from entering into the interior of the unit. The window screen system is particularly useful for hopper, awning, tilt and turn, and utility window designs.

In an example, the window screen system includes a window assembly to attach to a window having a permanent window frame and a movable window frame, wherein the permanent window frame includes a perimeter including a permanent bottom frame portion, a permanent first side frame portion, a permanent second side frame portion, and a permanent top frame portion, wherein the movable window frame includes a perimeter including a movable first frame portion, a movable first side frame portion, and a movable second side frame portion, wherein the movable window frame can move from a closed position to an open position. The present system can include an outer frame that attaches and surrounds the perimeter of the permanent window frame. The system can include an inner frame that attaches to the perimeter of the movable window frame. A screen is connected to both the outer frame and inner frame, such that the screen can be folded in an accordion type fashion in a closed position when the movable window frame is closed, and wherein the screen expands to an open position when the movable window frame is opened.

For example, in the closed position the perimeter of the movable window frame is in contact with the perimeter of the permanent window frame, wherein in the open position at least a portion of the perimeter of the movable window frame is not in contact with at least a portion of the permanent window frame, wherein upon the movable window frame moving from the closed position to the open position, the mesh screen covers a gap created between the permanent window frame and the movable window frame.

The screen can include two side portions and a central portion (e.g., top portion or bottom portion), wherein the central portion attaches to the side portions can be connected at corner portions. The corner portions can include reinforced screen material. For example, the screen portions can be overlapped to create a reinforced corner. Alternatively, or in addition to, an additional reinforcement material can be added to the corner portion. The reinforced corner portion can add durability and longevity to the screen.

An advantage of the present system is a screen that can be used with casement windows that keeps out bugs and other pests such as birds or vermin. While in America these creatures may pose an annoyance, elsewhere in the world these animals can threaten human life and spread many diseases. The screen system engages with casement windows, which typically do not have a screen system available.

Another advantage of the present is the system is not only keeping pests out, but also keeps pets and children within a residence. While not the strongest deterrent, a screen on a window that would otherwise be a wide-open gap may prevent pets and children from falling out of the window.

Yet another advantage of the present system is that it provides the potential for cost savings in the form of less electricity used to heat and cool a dwelling. Opening the windows when the weather permits prevents the need to run an HVAC system, lowering electricity costs and well as providing fresh air to a domicile. Such action is impractical for casement windows in areas with large pest populations since the dwelling will become inundated with bugs, etc. since no screen can readily be placed on this type of window. The present invention allows such a screen to be placed on windows that traditionally cannot accommodate one.

Still yet another advantage of the present system is that the low-profile design of the window screen apparatus does not block the view of the window on which the apparatus is placed. In many situations, casement windows are used over sash windows not only because of space requirements, but because casement windows allow for unimpeded views. Sash windows featuring a screen obstruct the window's view with a screen that also blocks sunlight. The present invention features a screen that covers the gap created by an open window, without the need to have the screen permanently visible over the window.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of an example of the screen system engaged with a window frame.

FIG. 2 is a perspective view of an example of a portion of the screen system engaged with a closed window frame.

FIG. 3 is a perspective view of an example of a portion of the screen system engaged with an opened window frame.

FIG. 4 is a cross sectional view of an example of the screen system engaged with a window frame.

### DETAILED DESCRIPTION OF THE INVENTION

The present disclosure is directed to a window screen system for use with windows to prevent dirt, debris, and insects from entering into the interior of the unit. Although the figures and examples typically illustrate an awning and/or hopper type of window, the window screen system is also useful for casement, utility, single hung, double hung, and tilt and turn window designs, among others. The system can be installed on existing window frames to provide screen protection only when the window is open and a screen is needed. As such, a user can have a clear view out of the glass window without the unsightliness, distortion, or solar blockage that a traditional “always visible” screen causes. The system disclosed is also applicable to windows that slide up and down, wherein the mesh screen extends from only the bottom portion of the permanent window frame to the bottom portion of the movable window frame, such that the screen is only seen or active when the window is slid open.

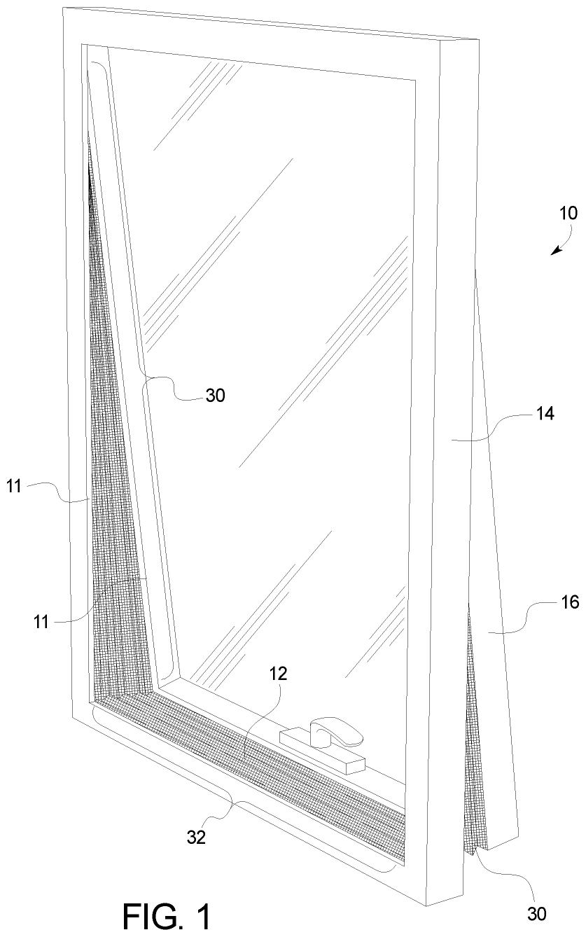

The window screen system can engage with a conventional window frame. As shown in FIG. 1, the screen system 10 includes an installment 11 including a mesh screen 12 that extends between the existing permanent window frame 14 and the moveable window frame 16. In an example, the installment 11 with the mesh screen 12 can be provided to a user in a fixed or adjustable size that adheres to an outer perimeter of the permanent window frame 14 and the movable window frame 16, wherein when assembled, the mesh screen covers a gap between the permanent window frame 14 and the movable window frame 16 when the movable window frame is open.

In an example, the window screen system includes an installment 11 to attach to a window having a permanent window frame 14 and a movable window frame 16, wherein the permanent window frame 14 includes a perimeter including a permanent bottom frame portion, a permanent first side frame portion, a permanent second side frame portion, and a permanent top frame portion, wherein the movable window frame 16 includes a perimeter including a movable first frame portion, a movable first side frame portion, and a movable second side frame portion, wherein the movable window frame can move from a closed position to an open position. The installment 11 can include any attachment mechanism to the permanent and movable window frames, including, but not limited to, adhesives, hooks, snaps, hook and loop systems, clasps, pressure fit, among others.

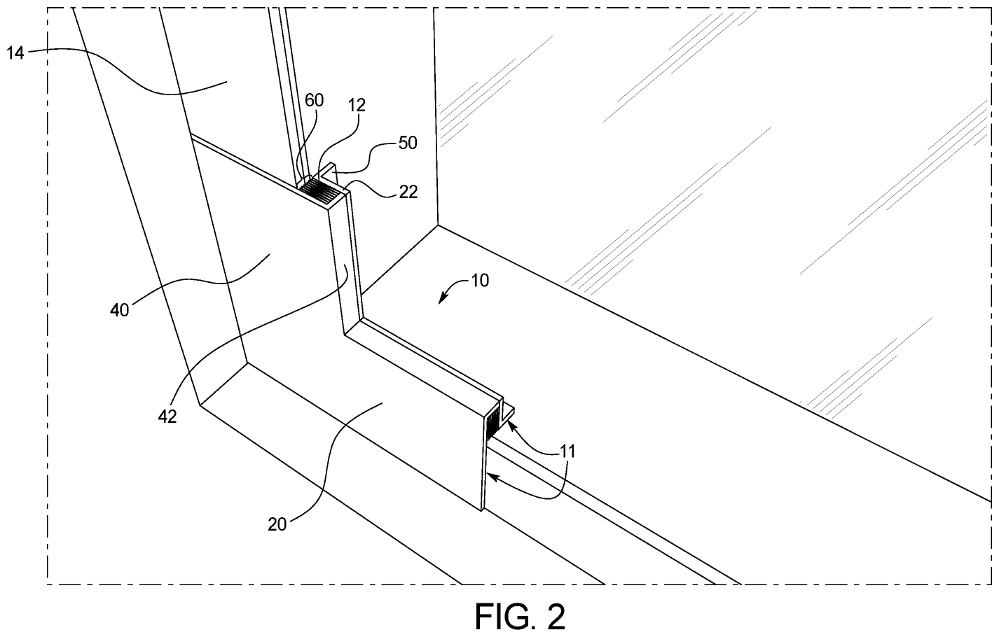

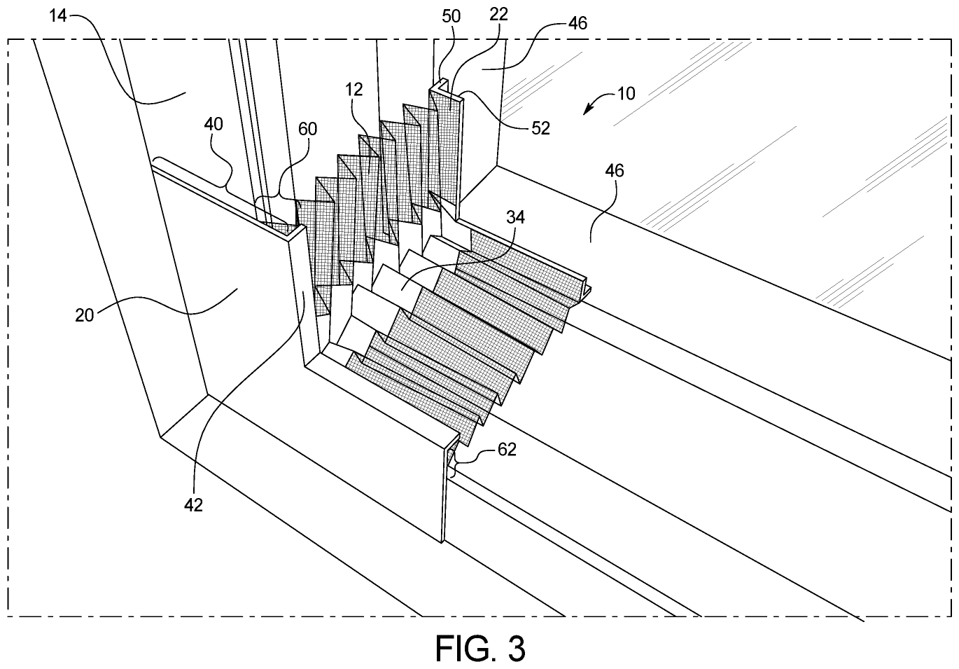

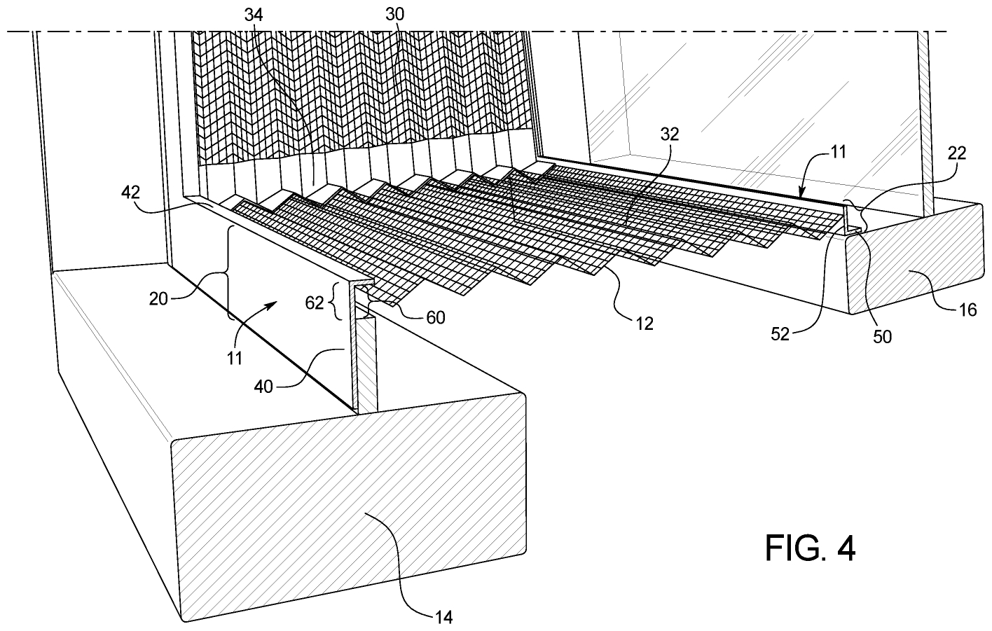

The installment 11 can include an outer frame 20 that attaches and surrounds the perimeter of the permanent window frame 14. The system can include an inner frame 22 that attaches to the perimeter of the movable window frame 16. The mesh screen 12 is connected to between the outer frame 20 and inner frame 22, such that the screen 12 can be folded in an accordion type fashion in a closed position when the movable window frame 16 is closed, as shown in FIG. 2, and wherein the screen 12 unfolds and expands to an open position when the movable window frame 16 is opened, as shown in FIGS. 3-4.

In an example, in the closed position the outer frame 20 can be in contact with the inner frame 22, wherein in the open position at least a portion of the inner frame 22 is not in contact with at least a portion of the outer frame 20. In an example, in the closed position the perimeter of the movable window frame can be in contact with the perimeter of the permanent window frame, wherein in the open position at least a portion of the perimeter of the movable window frame is not in contact with at least a portion of the permanent window frame, wherein upon the movable window frame moving from the closed position to the open position, the mesh screen covers a gap created between the permanent window frame 14 and the movable window frame 16.

In the closed position, the outer frame 20 and inner frame 22 can engage in a manner that conceals the mesh screen 12. For example, the outer frame 20 can include an outer planar face 40 that a portion of which can be positioned flush against the permanent window frame 14, wherein an extended portion 62 of the outer planar face 40 extends beyond the permanent window frame 14. The outer frame can include an outer lip 42 that is perpendicular to the outer planar face 40, wherein the outer lip 42 extends from an end of the outer planar face 40 that extends beyond the permanent window frame 14.

The inner frame 22 can include an inner attachment plate 50 attached to the moving window frame 16. For example, the inner attachment plate 50 can be flush against an inner surface 46 of the moving window frame 16, wherein the inner surface 46 can be perpendicular to the glass in window. The inner frame 22 can include an inner planar face 52, perpendicular to the inner attachment plate 50. In the closed position, the inner planar face 52, the outer lip 42, and the extended portion 62 of the outer planar face 40 extending beyond the permanent window frame 14 form a cavity 60 for housing the accordion folded mesh screen 12.

In an example, the pleated mesh screen 12 can adhere to the installment 11 such that the edge of the mesh screen 12 can be permanently attached to an edge piece that can be slide into a track that is positioned on the interior surface of the installment 11 (e.g., the inner planar face 52 and the extended portion 62). In an example, the edge piece can be a rigid (e.g., stiff fabric, plastic, etc.) that can be slide into a track on the installment 11, wherein the track can include a void to receive the edge piece. As such, the mesh screen 12 can be removed or retracted when there is a not needed when the window is opened, or when the screen 12 needs to be replaced.

The screen 12 can include two side portions 30 and a central portion 32 (e.g., top portion or bottom portion), wherein the central portion 32 attaches to the side portions 30 at corner portions 34. The corner portion 34 can include reinforced screen material. For example, the screen portions of the side portion 30 and central portion 32 can be overlapped to create a reinforced corner. Alternatively, or in addition to, an additional reinforcement material can be added to the corner portion 34. The reinforced corner portion 34 can add durability and longevity to the screen. Additional reinforcements may also be used to keep the screen taut for windows that open widely.

The central portion 32 and side portions 30 can extend from the inner planar face 52 to the extended portion 62 of the outer planar face 40 extending beyond the permanent window frame 14. When the window is opened, the central portion 32 and side portions 30 unfold from the cavity 60. Once the mesh portions are unfolded and extended, the edge of the first side portion can join with the first side edge of the central portion, and the edge of second side portion can join with the second side edge of the central portion, thereby creating a continuous mesh screen across the opening of the opened window.

The installment 11 can be made of any suitable material including plastic, aluminum, or rubber. The installment 11 material may be colored to match the window frame on which they are being placed to provide a uniform look. The installment 11 can be attached to the permanent window frame 14 by any suitable attachment. For example, the installment 11 can be adhered to the permanent window frame 14 with an adhesive, which leaves no residue when removed. The overall size of the apparatus may change depending on a given window's size and how far the window opens.

In an example, the central portion 32 extends beyond the bottom first corner of the window frame and partially up the first side of the window, and extends beyond the bottom second corner of the window and up a portion of the second side of the window. The side portions 30 can connect to the ends of the central portion to the respective top corners of the window. As a result, the edges of the central portion 32 and side portions 30 are not joined at the corner (e.g., perpendicular), and instead are joined in the same plane. Alternatively, the side portions 30 can extend beyond the respective corners to attach to the central portion 32 (i.e., the central portion does not extend from the first bottom corner to the second bottom corner).

In an example, the installment 11 does not interfere with the locking mechanism of the window. For example, conventional awning and hopper type windows can include an original locking mechanism that prevents the window from closing on its own, and typically automatically activates upon the window opening. An advantage of the installment 11 includes a user having access to a locking mechanism that can be activated by a user upon opening the window to keep the window open at the desired degree of openness.

Alternatively, or in addition to, installment 11 can include a button, lever, or other locking mechanism activator that a user can access to activate the locking mechanism, wherein the locking mechanism activator is mechanically or electrically in communication with the locking mechanism of the window. As a result, the user can activate the locking mechanism originally installed in the window without retracting the mesh screen. For example, the user can activate or deactivate the locking mechanism by a lever (e.g., deactivation arm) that travels underneath the mesh screen, between the screen and the housing, thus, not interfering with the screen and increasing excess wear. Alternatively, or in addition to, the mesh screen can be one continuous piece and/or separated into various portions, yet the mesh screen can be flexible enough for a user to access the original locking mechanism in the window by pushing through the screen to access the locking mechanism.

The mesh screen 12 can include aluminum, nylon, polyester, fiberglass, nylon/spandex blend, or combinations thereof. Typically, a mesh screen comprised of aluminum does not have a fatigue limit, therefore, the repetitive rolling or folding of the screen mesh can induce a break in the material. A mesh screen comprising fiberglass is typically not resistant to UV rays, and may deteriorate after prolonged use. A mesh screen comprising nylon and/or polyester are less likely to fatigue and are much more resilient, thus, having a longer lifetime. A nylon screen mesh and a polyester screen mesh can provide elasticity to the screen mesh. A mesh screen comprising polyester can have a fairly high glass transition temperature, and can exhibit less than desirable properties in colder temperatures. A mesh screen comprising a vinyl-coated polyester has optimal fatigue properties, as well as functional over a wide variety of temperatures.

In an example, the mesh screen may be aluminum insect screens. In other embodiments, the screens may be porous, stretchy fabric with sufficient porosity to permit airflow, but pore sizes that are sufficiently small to exclude insects from entry into a building.

The edges of the mesh portions can include any suitable attachment mechanism. For example, the edges can include a magnetic strip (or a series of magnetic strip pieces), zipper, tape, a series of magnets placed along the edges encased, hooks and loops, hooks and clasps, buttons, snaps, among others. The series of magnets along the edges can be placed within a fabric or two layers of the mesh screen. In an example, the magnets included neodymium magnets.

In an example, to reinforce the screen, the system can include one or a plurality of extending support rods that can telescope or fold out below the mesh screen to provide support to the mesh screen (e.g., to prevent sagging). For example, the support rods can extend and connect to the outer frame 20 and inner frame 22 (e.g., to the inner planar face 52 and the extended portion 62). In an example, the support rods can be provided on a track on the outer frame 20 and inner frame 22 such that when the window opens, the support rod moves along the track and extends out diagonally. When the window is closed, the rods are stored linearly, and flush against the outer frame 20 and inner frame 22 (e.g., the inner planar face 52 and the extended portion 62) within the tracks.

In an example, the mesh screen may not be a pleated screen, but a series of screen planar plates that can cascade into themselves and telescope out. When the window is closed, the plates are in a stored position wherein the plates they line up like a deck of cards. The plates can be stored in the cavity 60 when closed. When the window opens, the plates fan out to cover the gap between the outer frame 20 and inner frame 22.

It should be understood that notwithstanding the majority of examples include the screen system in conjunction with a window, the present system can also be used for any number of applications including, but not limited to, any other type of window, door, entryway, aperture, or porthole. Further, although the majority of the figures refer to a window wherein the moving window frame opens out to the exterior, it should be understood that the system is applicable to windows that open to the interior of the unit.

It should be noted that various changes and modifications to the presently preferred embodiments described herein will be apparent to those skilled in the art. Such changes and modifications may be made without departing from the spirit and scope of the present invention and without diminishing its attendant advantages.

1. A window screen system comprising:
an installment to attach to a window assembly, wherein the window assembly includes a permanent window frame and a movable window frame, wherein the permanent window frame surrounds a window plane, wherein the movable window frame moves from a closed position to an open position,
wherein the installment includes an outer frame and an inner frame, wherein the outer frame attaches to an outer perimeter of the permanent window frame, wherein the inner frame attaches to at least a portion of the inner perimeter of the moveable window frame;
a cavity, wherein in the closed position, the outer frame and the inner frame form the cavity; and
a mesh screen extending from the outer frame to the inner frame, wherein in the closed position, the mesh screen is stored in the cavity, wherein the mesh screen includes accordion folds,
wherein the accordion folds can move between a folded position and an unfolded position, wherein when the movable window frame is in the closed position the accordion folds are in the folded position, wherein when the movable window frame is in the open position the accordion folds are in the unfolded position,
wherein upon the movable window frame moving from the closed position to the open position, the mesh screen unfolds to cover a gap created between the permanent window frame and the movable window frame.

2. The system of claim 1, wherein the inner frame includes an inner attachment plate attached to the moving window frame, wherein the inner attachment plate attaches to an inner surface of the moving window frame, wherein the inner surface of the moving window frame is perpendicular to the window plane, wherein the inner frame includes an inner planar face perpendicular to the inner attachment plate.

3. The system of claim 2, wherein the outer frame includes an outer planar face, wherein a portion of the outer planar face attaches to an outer surface of the permanent window frame, wherein an extended portion of the outer planar face extends beyond the permanent window frame within a plane of the outer planar face, wherein the outer frame includes an outer lip perpendicular to the outer planar face, wherein the outer lip extends from an end of the extended portion of the outer planar face.

4. The system of claim 3, wherein the inner planar face, the outer lip, and the extended portion of the outer planar face define the cavity.

5. The window screen system of claim 1, wherein the mesh screen includes aluminum.

6. The window screen system of claim 1, wherein the mesh screen includes vinyl coated polyester.

7. A window screen system comprising:
an installment to attach to a window assembly, wherein the window assembly includes a permanent window frame and a movable window frame, wherein the movable window frame surrounds a window plane, wherein the movable window frame moves from a closed position to an open position,
wherein the installment includes an outer frame and an inner frame, wherein the outer frame attaches to at least a portion of an outer perimeter of the permanent window frame, wherein the inner frame attaches to at least a portion of the inner perimeter of the moveable window frame,
wherein the outer frame includes an outer planar face, wherein a portion of the outer planar face attaches to an outer surface of the permanent window frame, wherein an extended portion of the outer planar face extends beyond the permanent window frame within a plane of the outer planar face,
wherein the outer frame includes an outer lip perpendicular to the outer planar face, wherein the outer lip extends from an end of the extended portion of the outer planar face,
wherein the inner frame includes an inner attachment plate attached to the moving window frame, wherein the inner attachment plate attaches to an inner surface of the moving window frame, wherein the inner surface of the moving window frame is perpendicular to the window plane,
wherein the inner frame includes an inner planar face perpendicular to the inner attachment plate,
wherein the inner planar face, the outer lip, and the extended portion of the outer planar face define a cavity; and
a mesh screen extending from the inner planar face to the extended portion of the outer planar face, wherein in the closed position, the mesh screen is stored in the cavity,
wherein the mesh screen includes accordion folds, wherein the accordion folds can move between a folded position and an unfolded position,
wherein when the movable window frame is in the closed position the accordion folds are in the folded position within the cavity, wherein when the movable window frame is in the open position the accordion folds are in the unfolded position,
wherein upon the movable window frame moving from the closed position to the open position, the mesh screen unfolds to cover a gap created between the permanent window frame and the movable window frame.

8. The window screen system of claim 7, wherein the mesh screen includes aluminum.

9. The window screen system of claim 7, wherein the mesh screen includes vinyl coated polyester.

10. The system of claim 7, wherein the mesh screen includes
a central mesh screen portion extending from the inner frame attached to a movable bottom frame portion of the movable window frame to the outer frame attached to a permanent bottom window frame of the permanent window frame, wherein upon the movable window frame moving from the closed position to the open position, the central mesh screen unfolds to cover a central gap created between the permanent bottom window frame and the movable bottom window frame,
a first side mesh screen portion extending from the outer frame attached to a first side frame portion of the permanent window frame to the inner frame attached to the movable first side frame portion, wherein upon the movable window frame moving from the closed position to the open position, the first side mesh screen unfolds to cover a first side gap created between the permanent first side window frame and the movable first side window frame, and
a second side mesh screen portion extending from the outer frame attached to a permanent second side frame portion of the permanent window frame to the inner frame attached to a movable second side frame portion, wherein upon the movable window frame moving from the closed position to the open position, the second side mesh screen unfolds to cover a second side gap created between the permanent second side window frame and the movable second side window frame.

11. A window screen system comprising:
a window assembly including a permanent window frame and a movable window frame, wherein the permanent window frame includes a perimeter including a permanent bottom frame portion, a permanent first side frame portion, a permanent second side frame portion, and a permanent top frame portion,
wherein the movable window frame includes a perimeter including a movable bottom frame portion, a movable first side frame portion, and a movable second side frame portion, and a movable top frame portion,
wherein the movable window frame can move from a closed position to an open position, wherein in the closed position the perimeter of the movable window frame is in contact with the perimeter of the permanent window frame, wherein in the open position at least a portion of the perimeter of the movable window frame is not in contact with at least a portion of the permanent window frame;
an installment configured to attach to at least a portion of the permanent window frame, wherein the installment includes an outer frame and an inner frame, wherein the outer frame attaches to an outer perimeter of the permanent window frame, wherein the inner frame attaches to at least a portion of the inner perimeter of the moveable window frame;
a cavity, wherein in the closed position, the outer frame and the inner frame form the cavity; and
a mesh screen extending from the outer frame to the inner frame, wherein in the closed position, the mesh screen is stored in the cavity, wherein the mesh screen includes accordion folds, wherein the mesh screen includes
a central mesh screen portion extending from the inner frame attached to a movable bottom frame portion of the movable window frame to the outer frame attached to a permanent bottom window frame the permanent window frame, wherein upon the movable window frame moving from the closed position to the open position, the central mesh screen unfolds from the cavity to cover a central gap created between the permanent bottom window frame and the movable bottom window frame,
a first side mesh screen portion extending from the outer frame attached to a first side frame portion of the permanent window frame to the inner frame attached to the movable first side frame portion, wherein upon the movable window frame moving from the closed position to the open position, the first side mesh screen unfolds from the cavity to cover a first side gap created between the permanent first side window frame and the movable first side window frame, and
a second side mesh screen portion extending from the outer frame attached to a permanent second side frame portion of the permanent window frame to the inner frame attached to a movable second side frame portion, wherein upon the movable window frame moving from the closed position to the open position, the second side mesh screen unfolds from the cavity to cover a second side gap created between the permanent second side window frame and the movable second side window frame,
wherein each of the central side mesh screen portion, the first side mesh screen portion, the second side mesh screen portion include accordion folds, wherein the accordion folds can move between a folded position and an unfolded position,
wherein when the movable window frame is in the closed position the accordion folds are in the folded position, wherein when the movable window frame is in the open position the accordion folds are in the unfolded position.

12. The window screen system of claim 11, wherein the mesh screen includes aluminum.

13. The window screen system of claim 11, wherein the mesh screen includes vinyl coated polyester.
